(19) United States
(12) Patent Application Publication
(10) Pub. No.: US 2015/0036858 A1
(43) Pub. Date: Feb. 5, 2015

(54) Cube Speaker/Amplifier

(71) Applicant: Eyad Aboabdo, Anaheim, CA (US)

(72) Inventor: Eyad Aboabdo, Anaheim, CA (US)

(21) Appl. No.: 13/956,321

(22) Filed: Jul. 31, 2013

(51) Int. Cl. H04R 1/02

(52) U.S. Cl. CPC H04R 1/021
USPC 381/334

(57) ABSTRACT

A portable electronic device includes an electronic amplifier and a battery power supply in a lower hollow prismatic-shaped housing which has a rectangular base wall panel and an upper oblique wall panel which is disposed obliquely downwards between a rear panel and a front panel of the housing, and an upper housing containing a loudspeaker which has a hollow prismatic shape including a lower oblique wall panel which is disposed downwardly between the rear wall panel of the housing and a front wall panel of the housing. Confronting outer faces of the oblique housing wall panels are joined by a central hollow rotatable joint which receives therethrough electrical leads that connect the loudspeaker to the amplifier. In a first, 0-degree orientation of the amplifier housing relative to the speaker housing, the composite shape of the device approximates that of a cube. The rotatable joint facilitates rotational motion of the speaker housing relative to the amplifier housing to a first, 90-degree orientation and a second, 180-degree orientation, to thus direct the sounds from the loudspeaker in different selected directions.

### BACKGROUND OF THE INVENTION

A. Field of the Invention

The present invention relates to portable audio equipment. More particularly, the invention relates to a portable battery powered combination loudspeaker and amplifier for receiving audio frequency electrical signals and amplifying the electrical signals to produce music or speech sounds which are emitted by the loudspeaker in a variety of selectable directions.

B. Description of Background Art

There is a wide variety of portable electronic devices which are capable of receiving audio frequency signals such as voice communications and music. Some such devices are capable of receiving and recording in internal electronic memory, i.e., downloading audio frequency signals. The electrical signals are amplified and input to a loudspeaker, which converts the electrical signals to audible sounds which are emitted from the loudspeaker. Devices of the type described above include cell phones, MP3 players, portable computers and the like. Because of the small size of devices such as MP3 players and cell phones, loudspeakers in such devices are necessarily small, and thus inherently limit the fidelity of sounds emitted by the loudspeaker. Accordingly, it would be desirable to provide a portable auxiliary device which contained a loudspeaker of sufficient size to reproduce sounds such as music with greater fidelity than available from small devices which receive or produce audio frequency signals. It would also be desirable to provide a portable auxiliary loudspeaker device which included an electronic amplifier for amplifying low level audio signals and an integral battery for powering the amplifier. There are available a variety of portable amplifier/loudspeaker devices of the type described above. However, there remains a need for a portable loudspeaker and amplifier device which can be placed on a desk top or other such supporting surface, and the speaker swiveled or pivoted with respect to the supporting surface, so that high fidelity sounds can be emitted from the loudspeaker and projected in different selectable directions. It would also be desirable to provide a portable amplifier with an integral loudspeaker pointable in different directions which had an internal electrical power source. The foregoing considerations were a motivation for the present invention.

### OBJECTS OF THE INVENTION

An object of the present invention is to provide a portable electronic device which includes a lower base housing that contains an electronic amplifier for receiving audio frequency electrical signals, and an upper loudspeaker housing which contains a loudspeaker and is swivelable to different angular orientations relative to the base housing, to thus direct sounds emitted by the loudspeaker in different selectable orientations relative to a support surface on which the base housing is placed.

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, I do not intend that the scope of my exclusive rights and privileges in the invention be limited to details of the embodiments described. I do intend that equivalents, adaptations and modifications of the invention reasonably inferable from the description contained herein be included within the scope of the invention as defined by the appended claims.

### SUMMARY OF THE INVENTION

Briefly stated, the present invention comprehends a portable electronic device which includes an upper speaker housing that contains a loudspeaker, and a lower, base housing that contains an electronic amplifier and rotatably supports the speaker housing. The amplifier housing also contains a battery holder and battery for powering the amplifier, and input jacks for receiving audio signals from portable electronic devices such as cellphones, MP3 players and the like. Low power audio signals input to the amplifier are amplified and input to the loudspeaker. A preferred embodiment of the device includes a Bluetooth radio frequency transceiver for receiving wireless audio signals, and a rechargeable battery which may be recharged from a powered USB port.

According to the invention, the speaker and amplifier housings are joined together by a rotatable joint which in a first position orients the housings to form a cube-shaped unit, which has a flat, generally square plan-view base for placement on a support surface such as a table or desk. The speaker housing has a generally square plan-view speaker grille inset into an opening in the upper face of the cube, which is disposed parallel to the flat base of the amplifier housing. Thus, the speaker grille is disposed in a horizontal plane parallel to a desk top or table on which the device is placed, when the speaker housing is rotatably oriented in a first, zero-degree home position relative to the amplifier housing.

The amplifier housing of the speaker/amplifier device according to the present invention has generally the shape of a hollow rectangular prism which is truncated by replacing a flat upper face of the cube which was perpendicular to vertical sides of the cube by an upper oblique face which slopes downwards and forwards from the rear face of the cube at about a 45-degree angle.

The speaker housing containing the loudspeaker has a shape complementary to that of the amplifier housing, having the shape of a cube truncated by a lower oblique face which is angled upwardly and rearwardly at about a 45-degree angle from the front face of the base housing. Thus, when the lower oblique face of the speaker housing congruently contacts the upper oblique face of the upper oblique wall panel of the amplifier housing, the composite shape of the upper, loudspeaker housing and lower, amplifier housing approximates that of a hollow cube. The outer walls of the cube are thin uniform thickness panels.

The lower obliquely angled face of the upper speaker housing containing the loud speaker is rotatably attached to the contacting upper obliquely angled face of the lower amplifier housing by a central perforated rotatable joint. The rotatable joint includes an annular ring-shaped groove in the upper angled face of the upper oblique lower amplifier housing. The rotatable joint also includes an annular ring-shaped flange which protrudes downwardly from the lower face of the lower oblique wall panel of the upper speaker housing, the flange being rotatably received within the annular groove in the upper oblique face of the lower amplifier housing.

The upper and lower oblique faces of the amplifier and speaker housings are restrained against axial motion perpendicular to their mating faces by a trifurcated tubular snap ring which has three axially downwardly protruding legs. The three snap ring legs are elastically deformable radially inwardly to enable the legs to be inserted downwardly through a central clearance aperture through the lower oblique wall panel of the speaker housing, and into an interference fit through a smaller diameter central aperture through the upper oblique wall panel of the amplifier housing located below the lower speaker housing panel.

The lower end of each snap-ring leg has a radially inwardly protruding, transversely disposed shoulder flange. When the legs emerge below the lower surface of the upper oblique wall panel of the lower amplifier housing, elasticity of the legs causes the shoulder flanges to spring radially inwardly beyond the lower circumferential edge of the central aperture through the upper oblique wall panel of the amplifier housing, thus locking the upper and lower housings against relative axial movement but enabling relative rotatable movement between the housings.

In a first, zero-degree “home” position of the upper speaker housing relative to the lower amplifier housing, the front, rear, left and right outer sides of the speaker housing are co-planar with corresponding outer sides of the amplifier housing. Consequently, in this home position, the composite shape of the speaker/amplifier is that of a parallelepiped, approximating that of a cube. In a preferred embodiment, the relative dimensions of the amplifier and speaker housings differ slightly from those of a perfect cube. Thus, in an example embodiment, with the speaker housing vertically aligned with the amplifier housing, the speaker/amplifier had a front-to-rear depth of 2½ inches, a width of 3 inches, and a height of 2½ inches.

In the example embodiment, the upper face of the forwardly and downwardly sloping oblique upper wall panel of the lower amplifier housing intersected the outer vertical surface front wall panel of the amplifier housing along a horizontal intersection line which was located about ⅜ inch above the lower edge of the front wall panel.

Also in the example embodiment, the lower face of the rearwardly and upwardly sloping oblique lower wall panel of the upper speaker housing intersected the outer vertical surface of the rear wall panel of the speaker housing along a horizontal line which was located about ⅝ inch below the upper edge of the rear wall panel.

In the example embodiment of the speaker/amplifier which had the foregoing relative dimensions, with the relative rotational orientation between the upper speaker housing and lower amplifier housing at a zero-degree, home value, the lower oblique face of the upper speaker housing contacted the upper oblique face of the lower amplifier housing in a plane which perpendicularly penetrates the left and right vertical side walls of the composite cube formed by the rotatably conjoined upper and lower housing sections. The outer edges of the contact plane formed diagonally disposed, 3-inch long traces in the left and right sides of the cube-like composite housing thus formed. In this home position, the upper flat surface of the speaker grille is parallel to the lower base surface of the amplifier housing. Thus positioned, sounds emitted by the speaker are directed in an upward vertical direction, perpendicularly to the speaker grille and a supporting surface such as a table top on which the speaker/amplifier is placed.

According to the invention, a second configuration of the speaker/amplifier is obtained by grasping the lower, amplifier housing in one hand, grasping the upper speaker housing in the other hand, and turning the speaker housing 90 degrees counterclockwise relative to the amplifier housing. By so doing, the lower edge of the rear upper wall section of the speaker housing is rotated from its initial home position in contact with the upper edge of the rear wall section of the amplifier housing, to a position contacting the oblique left edge of the upper oblique face of the lower amplifier housing. In this position, contacting oblique faces of the speaker and amplifier housing position the speaker grille at an orientation in which a normal center line of the speaker is angled at about 45 degrees forward and 45 degrees to the left, relative to the base of the amplifier housing. Thus, in this second configuration, sounds emitted from the speaker are directed obliquely forward and to the left, relative to the base of the amplifier housing.

Rotating the speaker housing another 90 degrees, i.e., 180 degrees counterclockwise relative to its home orientation relative to the amplifier housing, produces a third configuration of the speaker/amplifier according to the present invention. In this third configuration, the lower edge of the upper short rear panel wall section of the upper speaker housing contacts the upper short edge of the lower short front panel wall section of the lower amplifier housing. In this configuration, a center line perpendicular to the speaker grille is angled at about 45 degrees upwardly and forward from the base of the amplifier housing. Thus, in this position, sounds emitted by the speaker are directed predominately in a 45 degree upward direction upwardly and forwardly relative to the base of amplifier housing.

To restore the speaker/amplifier unit to an original, most-compact cube-like configuration, the speaker housing is rotated clockwise relative to the amplifier base to the zero-degree home position in two 90-degree increments, i.e., a total of 180 degrees clockwise.

### BRIEF DESCRIPTION OF THE DRAWINGS

FIG. 1 is a right front perspective view of a portable loudspeaker and amplifier device according to the present invention.

FIG. 2 is a front elevation view of the loudspeaker/amplifier of FIG. 1.

FIG. 3 is a right side elevation view of the loudspeaker/amplifier of FIG. 1.

FIG. 4 is a rear elevation view of the loudspeaker/amplifier of FIG. 1.

FIG. 5 is a left side elevation view of the loudspeaker/amplifier of FIG. 1.

FIG. 6 is an upper plan view of the loudspeaker/amplifier of FIG. 1.

FIG. 7 is a bottom plan view of the loudspeaker/amplifier of FIG. 1.

FIG. 8 is a fragmentary exploded lower perspective view of the loudspeaker/amplifier of FIG. 1, showing a battery compartment door thereof removed.

FIG. 9 is a fragmentary exploded upper perspective view of the loudspeaker/amplifier of FIG. 1, showing an upper, and lower, speaker housing and amplifier housing thereof disassembled from one another, and showing a snap ring for rotatably joining the housings, preparatory to installing the snap ring.

FIG. 10 is a fragmentary upper plan view showing the upper oblique mating plane face of the lower, amplifier housing of FIG. 9.

FIG. 11 a fragmentary lower plan view showing the lower oblique mating plane face of the upper, speaker housing of FIG. 9.

FIG. 12A is an upper plan view of the snap ring of FIG. 9.

FIG. 12B is an upper perspective view of the snap ring of FIG. 9.

FIG. 13A is a lower plan view of the snap ring of FIG. 9.

FIG. 13B is a lower perspective view of the snap ring of FIG. 9.

FIG. 14 is an upper plan view of the upper, speaker housing of FIG. 9.

FIG. 15 is a lower plan view of the lower, amplifier housing of FIG. 9.

FIG. 16 is a vertical medial sectional view showing the upper and lower housings of FIG. 9 preparatory to their being rotatably fastened together.

FIG. 17 is a vertical medial section view of the upper and lower housings of FIG. 9, showing downwardly protruding legs of the snap ring of FIGS. 12 and 13 inserted through a central clearance aperture through the bottom oblique wall panel of the upper housing into in an interference fit within an axially aligned aperture through the upper oblique wall panel of the lower housing to thus rotatably join together the two housings.

FIG. 18 is a front perspective view of the loudspeaker/amplifier of FIG. 1 in a first, 0-degree home configuration, with the upper housing containing the loudspeaker oriented parallel to the lower housing containing the amplifier.

FIG. 19 is a front perspective view of the loudspeaker amplifier of FIG. 1 in a second configuration showing the upper speaker housing rotated 90 degrees counter-clockwise relative to the lower amplifier housing.

FIG. 20 is a right side perspective view of the arrangement of FIG. 19.

FIG. 21 is a left side perspective view of the arrangement of FIG. 19.

FIG. 22 is a front perspective showing the loudspeaker housing in a third configuration rotated 180 degrees counter-clockwise relative to the amplifier housing.

FIG. 23 is a right side perspective view of the arrangement of FIG. 22.

FIG. 24 is a left side perspective view of the arrangement of FIG. 22.

### DESCRIPTION OF THE PREFERRED EMBODIMENT

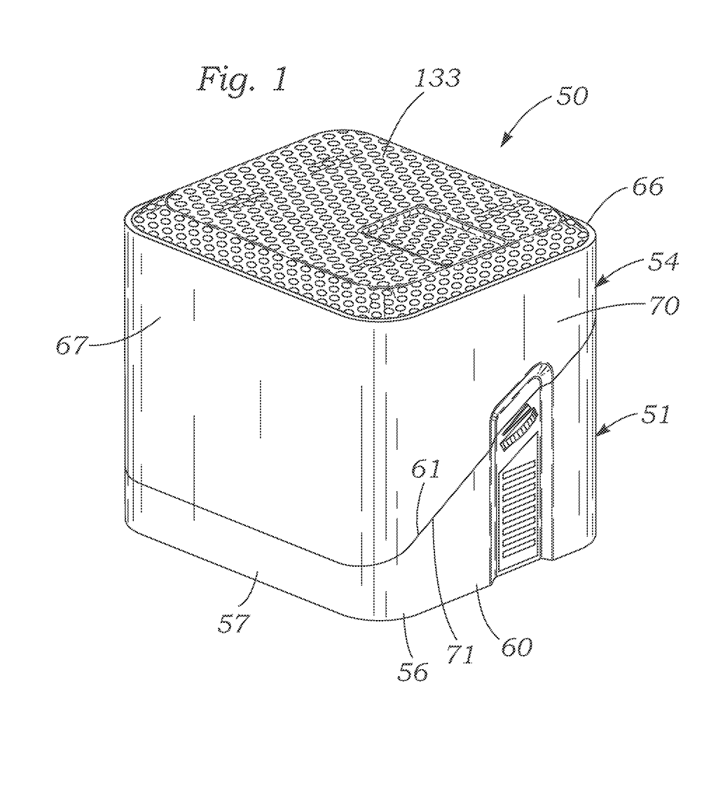

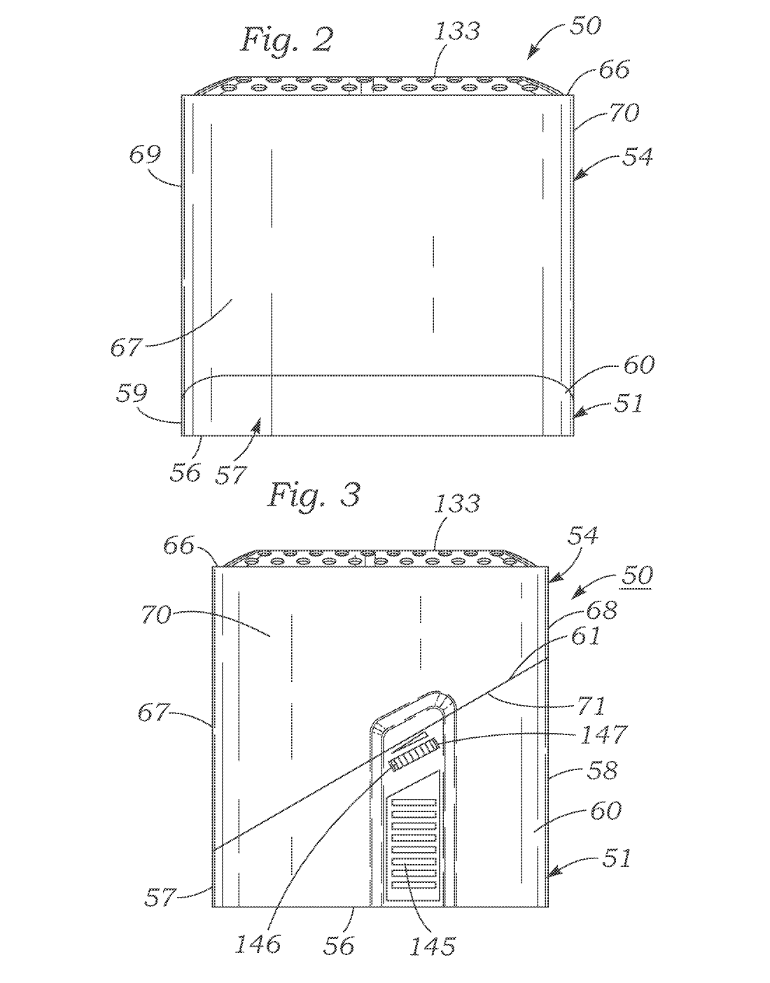

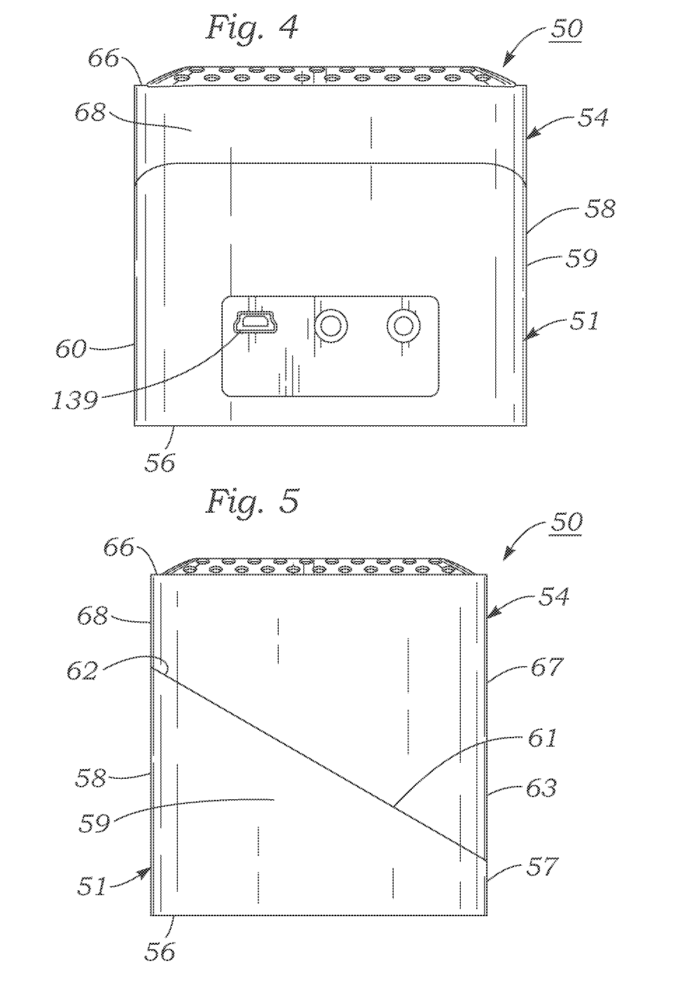

FIGS. 1-7 and 18 illustrate a portable loudspeaker and integral amplifier device according to the present invention, in a first, compact, 0-degree home configuration in which an upper, loudspeaker housing of the device is rotatably oriented with respect to a lower, amplifier housing to position the two housings in vertical alignment.

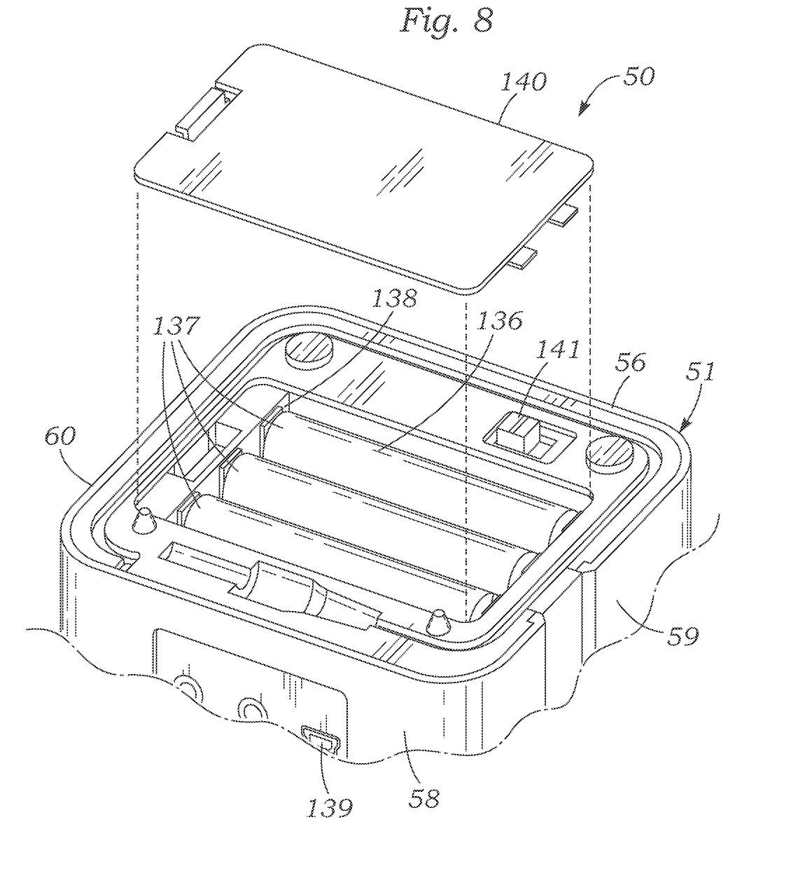

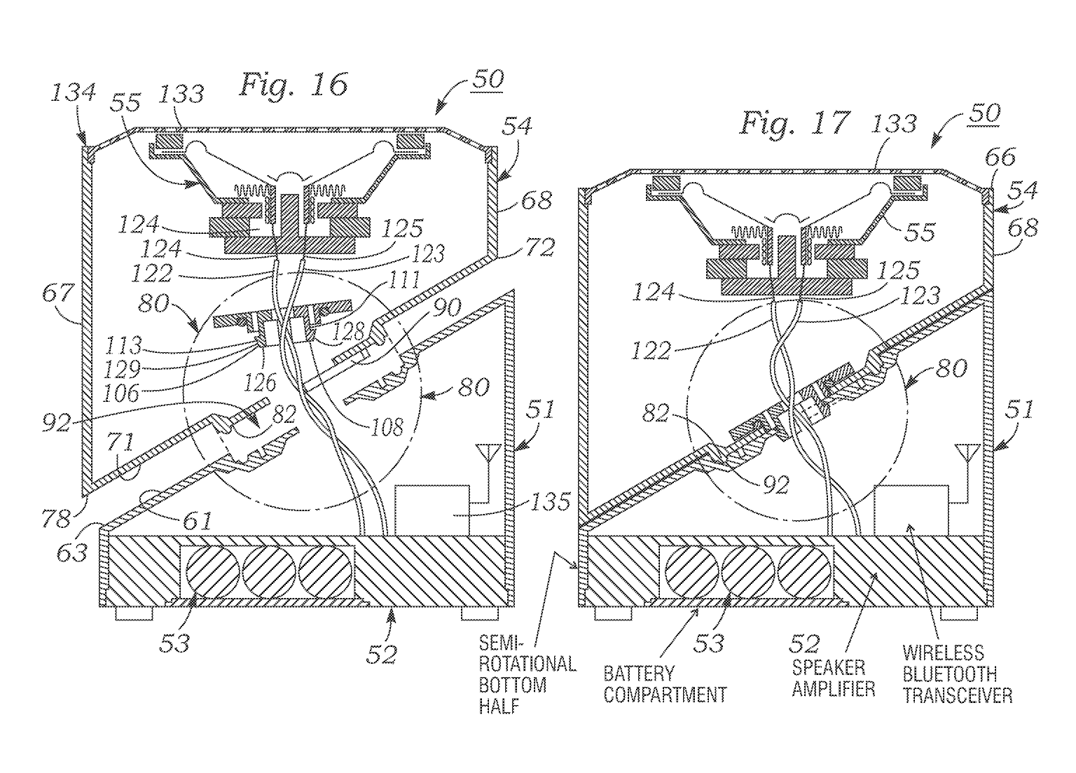

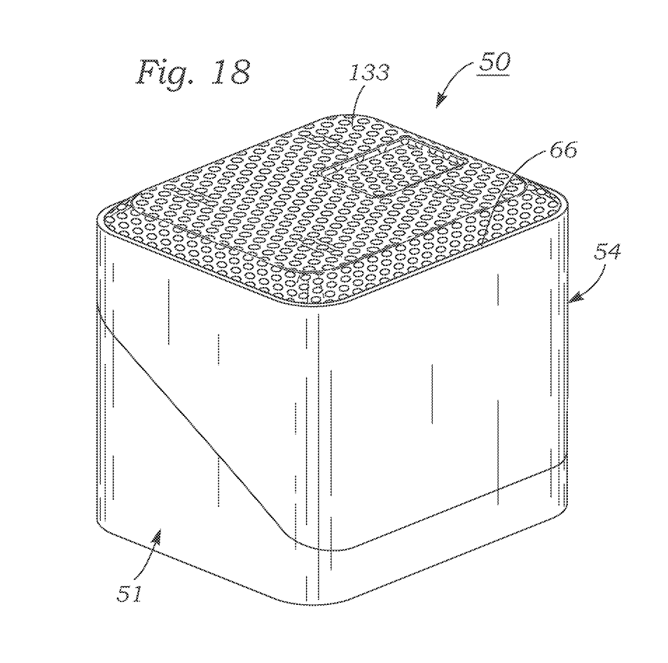

FIGS. 8-17 illustrate construction details of the speaker/amplifier device of FIGS. 1-7.

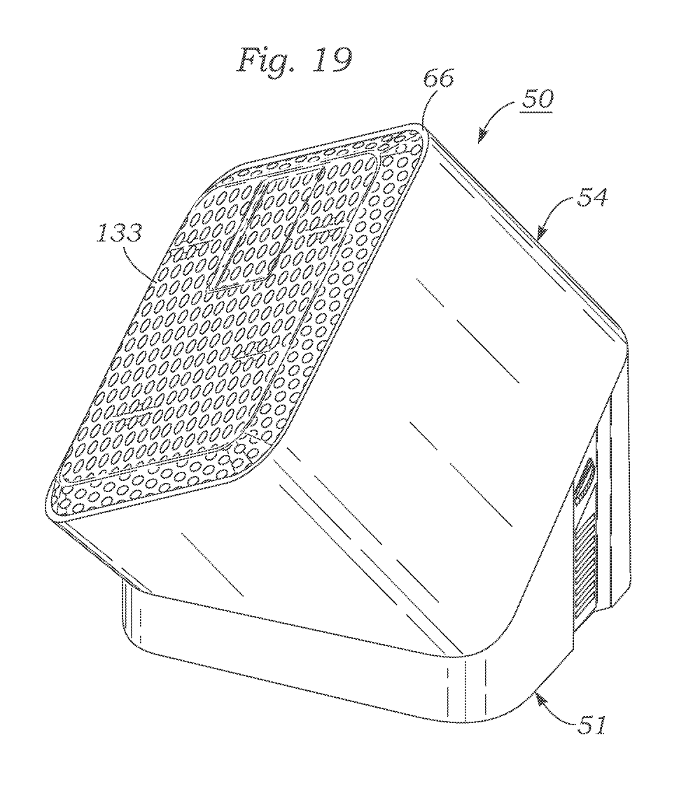

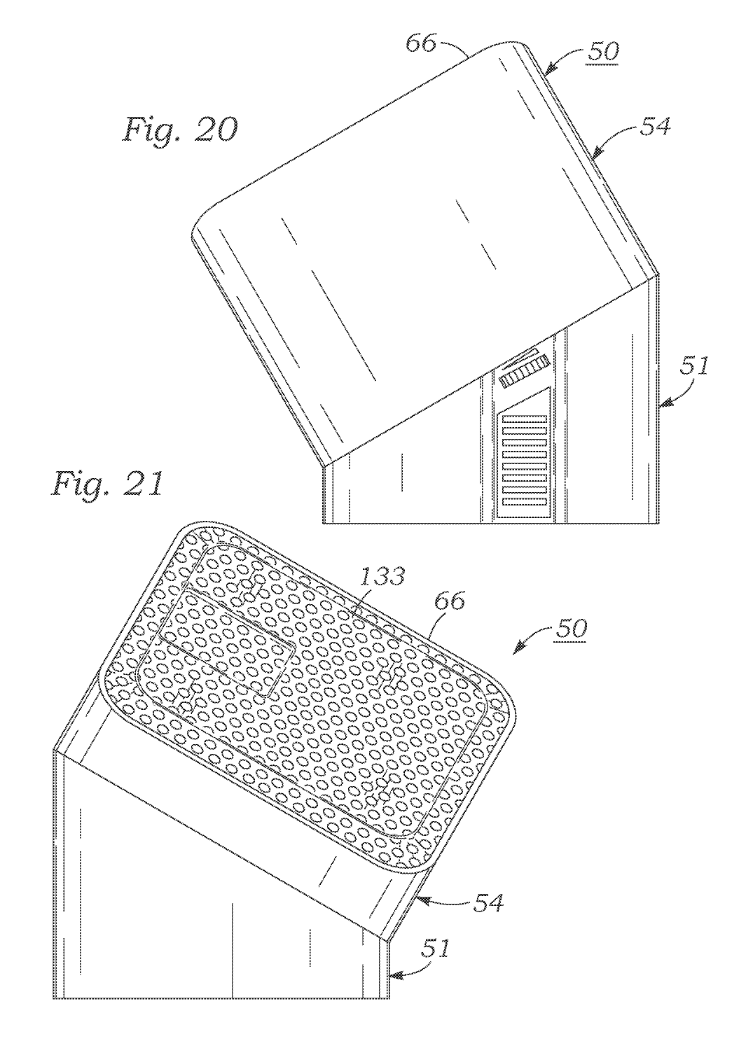

FIGS. 19-21 illustrate a second configuration of the device of FIG. 1, in which the upper speaker housing is rotated 90 degrees counterclockwise relative to the lower amplifier housing to thus direct sounds from the speaker in an obliquely upwardly angled direction.

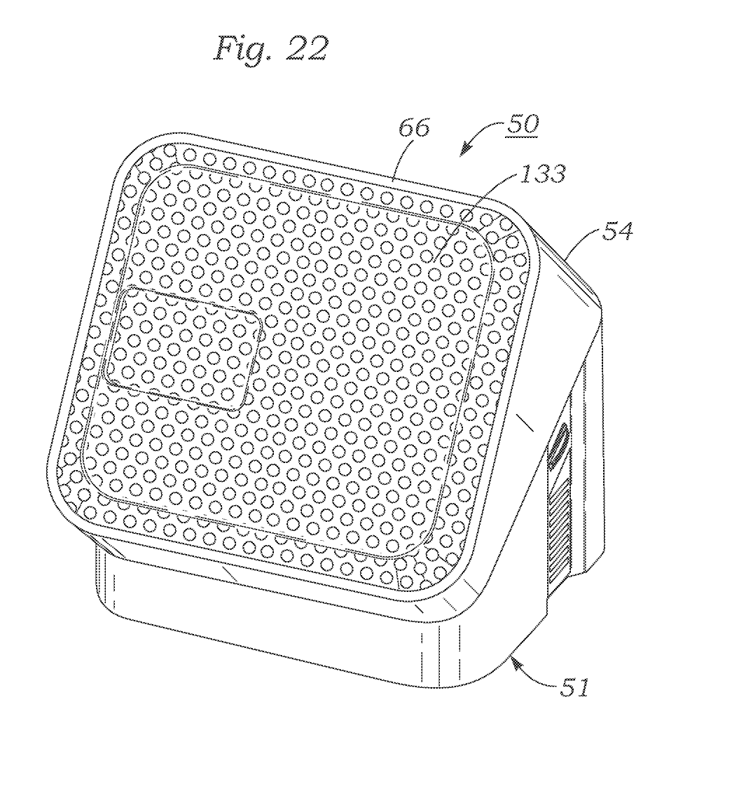

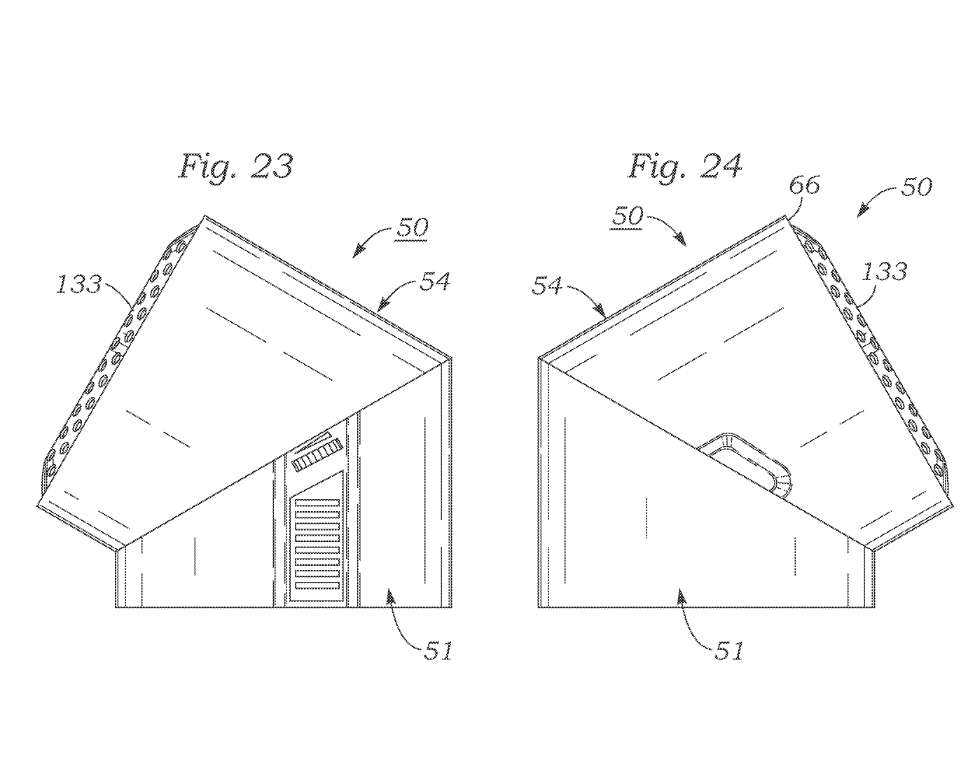

FIGS. 22-24 illustrate a third configuration of the device of FIG. 1, in which the speaker housing is rotated 180 degrees counterclockwise relative to the amplifier housing, to thus direct sounds from the speaker in a forwardly and upwardly angled direction.

Referring now to FIGS. 1-7, 16 and 17, it may be seen that a portable loudspeaker/amplifier device 50 according to the present invention includes a lower, base housing section 51 which contains an amplifier 52 and a power supply 53, and an upper, speaker housing section 54 which contains a loudspeaker 55. As shown in FIGS. 1-7, the amplifier base housing 51 has generally the shape of a truncated hollow rectangular prism.

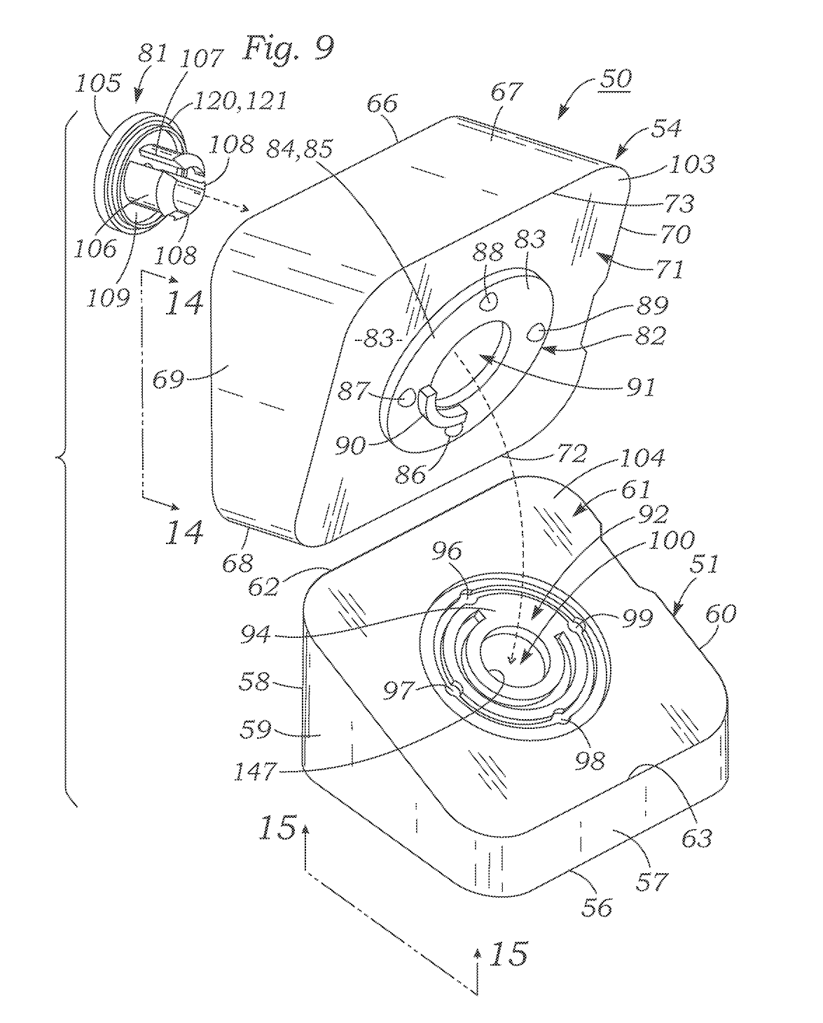

As shown in FIG. 9, amplifier base housing 51 has a flat, rectangular-shaped base wall 56, a laterally disposed front vertical wall 57 which protrudes perpendicularly upwards from the base wall, a laterally disposed rear wall 58 which is parallel to the front wall and protrudes perpendicularly upwards from the base wall, and parallel left and right vertical side walls 59, 60 which are perpendicular to the front and rear walls and the base wall.

As is also shown in FIGS. 9,16 and 17, an upper end of amplifier base housing 51 of speaker/amplifier device 50 is truncated by an upper flat oblique wall panel 61 which is disposed downwardly and forwardly from a rear upper edge 62 of rear wall 58 to a front upper edge 63 of front wall 57.

As shown in FIG. 9, the rear and front edges 62 and 63 of rear and front walls 56, 57 of amplifier base housing 51 are parallel to base wall 56 of base section 51. As may be seen best by referring to FIGS. 3 and 5, oblique upper wall panel 61 is perpendicular to left and right side walls 59. 60 and inclined at a dihedral angle of 45 degrees to front and rear side walls 57 and 58 of amplifier base housing 51.

Referring to FIGS. 1-7, 9, 16 and 17, it may be seen that the upper, speaker housing 54 of amplifier/speaker 50 has a shape which is complementary to that of amplifier base housing 51, i.e., that of an inverted rectangular prism which is truncated by an obliquely angled lower end face that is perpendicular to the side walls of the prism. Thus, as shown in FIGS. 1-7 and 9, upper speaker housing 54 of speaker/amplifier device 50 has a flat rectangular ring-shaped upper end wall 66, a front laterally disposed vertical wall 67 which protrudes perpendicularly downwards from the upper end wall, a rear laterally disposed rear wall 68 which is parallel to the front wall that protrudes perpendicularly downwards from the upper end wall, and parallel left and right vertical side wall 69, 70 which depend perpendicularly downward from the upper end wall and are perpendicular to the front and rear walls and the upper end wall.

As shown in FIGS. 9, 16 and 17, speaker housing 55 of speaker/amplifier device 50 has a lower flat oblique wall panel 71 which is disposed downwardly and forwardly from a rear lower edge 72 of rear wall 68 to a front lower edge 73 of front wall 67 of the speaker housing.

As shown in FIG. 9, the front and rear edges 72, 73 of rear and front walls 68, 67 of speaker housing 54 are parallel to upper edge wall 66 of speaker housing 54. As may be seen best by referring to FIGS. 3 and 5, oblique lower wall panel 71 of speaker housing 54 is perpendicular to left and right side walls 69 and 70, and inclined at a dihedral angle of 45 degrees to front and rear walls 71 and 72 of speaker housing 54. Thus, as shown in FIGS. 3, 4 and 17, when the upper speaker housing 54 is vertically aligned with lower amplifier housing 51, the oblique lower face of the oblique lower panel 71 of the upper speaker housing congruently contacts the upper face of the upper oblique panel wall 61 of the lower amplifier base housing, and the frusto-prismatically shaped upper and lower “semi-cube” housings 54 and 51 form a parallelepiped which has a shape that approximates that of a cube.

As shown in FIGS. 1, 3 and 5, the dimensions of the speaker/amplifier device 50 may differ somewhat from those of a perfect cube. Thus, the example embodiment of the speaker/amplifier device shown in FIGS. 1, 3 and 5 had a width of about 3 inches, a height of about 2½ inches, a front wall height of about ⅜ inch, and a rear wall height of about ⅝ inch.

FIGS. 9-18 illustrate how upper, speaker housing 54 is rotatably joined to lower amplifier housing 51 by means of a rotatable joint 80 which includes a tubular snap ring 81. As shown in those figures, joint 80 includes a thin circular boss 82 which protrudes downwardly from the lower surface 83 of the center of oblique lower panel wall 71 of upper speaker housing 54.

As may be seen best by referring to FIGS. 9, 11, 16 and 17, speaker housing boss 82 has generally the shape of a flat, circular annular ring 84 which has a flat annular ring-shaped lower surface 85. Lower surface 85 has protruding downwardly therefrom 4 small hemispherically-shaped indexing detent buttons 86, 87, 88, 89 which are spaced circumferentially apart at 90-degree intervals. Ring 84 also has protruding downward from lower surface 85 thereof a rectangular transverse cross section indexing rib 90. Indexing rib 90 has in plan view the shape of a 90-degree long circular arc segment. Rib 90 is disposed circumferentially between detent buttons 86, 87, at a radial location between a central coaxial aperture 91 through the boss 82, and radially inwardly located sides of the detent buttons.

As shown in FIGS. 9, 10 and 16, joint 80 includes a thin, shallow circular depression 92 in the upper surface 93 of the upper oblique panel wall 61 of lower amplifier base housing 51. As shown in FIG. 16, depression 92 is centrally located in upper oblique panel wall 61 of lower amplifier base housing 51, and is of slightly larger diameter than speaker housing boss 82, so that it may conformally and rotatably receive the downwardly protruding parts of the speaker housing boss.

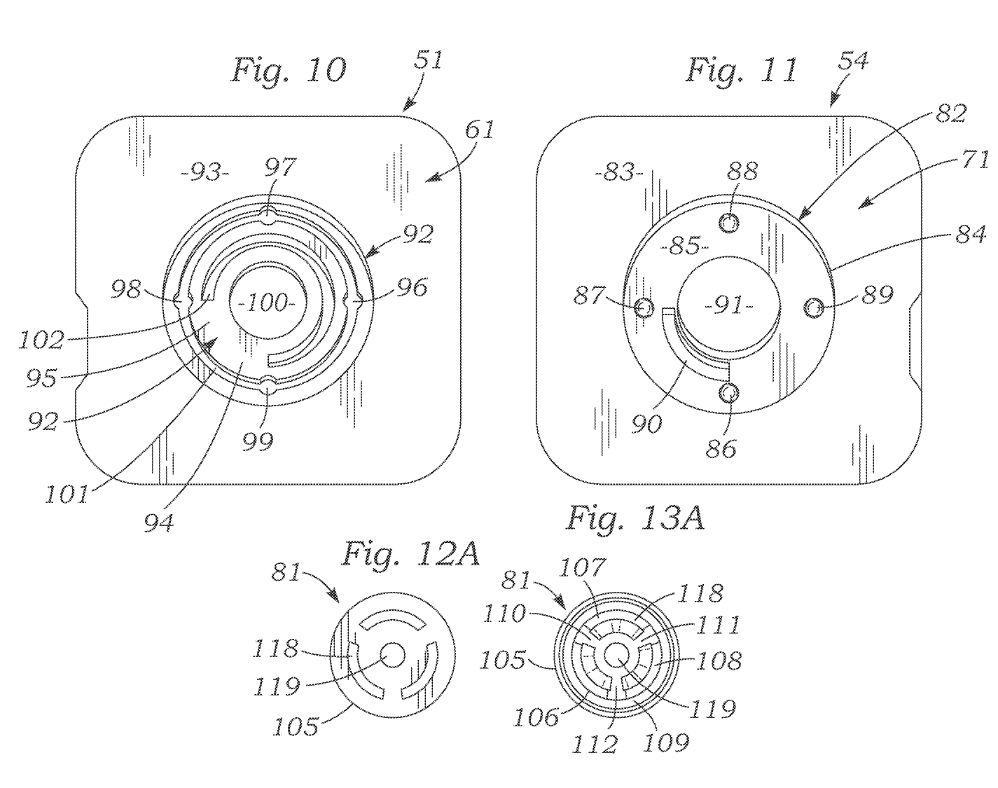

As may be seen best by referring to FIGS. 9 and 10, depression 92 in upper oblique panel wall 61 of amplifier base housing 51 has formed in the upper flat annular ring-shaped wall 94 thereof a circular groove 95. Groove 95 has the same diameter as that of a circle on which detent buttons 86-89 of speaker housing boss 82 are located.

As shown in FIGS. 9 and 10, circular ring-shaped groove 95 in upper oblique panel wall 61 of amplifier housing 51 has a generally rectangularly-shaped transverse cross section. Groove 95 also has formed therein four generally hemispherically-shaped detent depressions 96, 97, 98, 99 which are circumferentially spaced apart at 90-degree intervals and of an appropriate diameter to receive detent buttons 86, 87, 88, 89.

Referring to FIGS. 9 and 10, depression 92 in upper oblique wall panel 61 of lower amplifier housing 51 has through its thickness dimension a central circular aperture 100. As is also shown in FIGS. 9 and 10, depression 92 has formed in lower wall surface 101 thereof a circular arc-shaped groove 102. Groove 102 has a rectangular transverse cross-sectional shape, and an arc length of about 270 degrees. Arc-shaped groove 102 is of an appropriate size to insertably and rotatably slidably receive the 90-degree long indexing rib 90 which protrudes downwardly from speaker housing boss 82.

With the foregoing construction, speaker housing boss 82 is conformally receivable downwardly and rotatably to thus position lower face 103 of oblique panel wall 71 of speaker housing 54 within circular depression 92 in upper surface 104 of amplifier housing 51. In this position, the lower planar surface 103 of oblique lower panel wall 71 of the speaker housing rotatably slidably contacts the upper planar surface 104 of oblique upper panel wall 61 of the amplifier housing 51.

FIGS. 9-17 illustrate construction details of joint 80 which facilitates rotational motion of speaker housing 54 relative to amplifier housing 51, while maintaining the facing surfaces of the oblique planes of the housing in mutually slidable contact, and restrained against perpendicular relative notion between the planes.

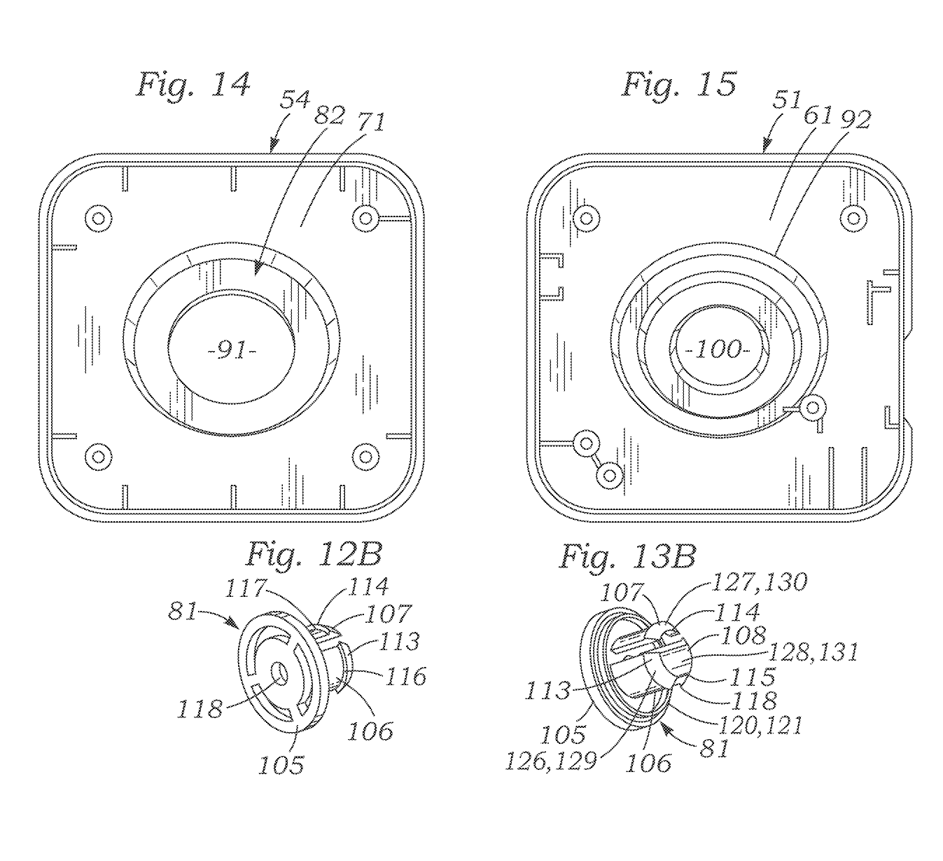

As shown in FIGS. 12A-13B, 16 and 17, snap ring 81 of rotatable joint 80 has an upper flat circular disk-shaped head 105 and three flanged gripper legs 106, 107, 108 which protrude perpendicularly downwards from the lower flat surface 109 of the head. As may be seen best by referring to FIGS. 12B, 13B and 16, legs 106, 107, 108 are axially disposed sections of a hollow cylindrical tube which is coaxial with head 105, the tube being segmented or trifurcated into three identically shaped separate legs which are circumferentially spaced apart at 120-degree intervals by three axially disposed slots 110, 111, 112, that are also spaced circumferentially apart at 120 degree intervals.

Snap ring 81 is made of a material such as nylon or other hard plastic which enables lower ends of gripping legs 106, 107, 108 to elastically deform in radial directions.

As shown in FIGS. 12B and 13B, each leg 106, 107, 108 has at the lower end thereof a radially outwardly protruding shoulder flange or barb 113, 114, 115. As may be seen best by referring to FIG. 16, each barb 113, 114, 115 has a flat, radially aligned shoulder 116, 117, 118.

As may be seen best by referring to FIGS. 12A, 12B and 13A, snap ring fastener 81 has through the thickness dimension of circular disk-shaped head 105 thereof is a central coaxial clearance hole 119. As may be seen best by referring to FIGS. 13A, 13B and 16, lower face 109 of head 105 of snap ring 81 has formed therein a shallow ring-shaped groove 120 which receives an elastomeric O-ring 121.

FIGS. 16 and 17 illustrate how snap ring 81 is used to rotatably fasten speaker housing 54 to amplifier housing 51. As shown in FIGS. 16 and 17, speaker driver wires 122, 123 from amplifier 53 are first strung through central aperture 100 through upper oblique panel wall 61 of amplifier housing 51. The wires are then strung through central aperture 91 through lower oblique panel wall 71 of speaker housing 54, through central clearance hole 119 through snap ring 81, and soldered to terminals 124, 125 of loudspeaker 55.

Next, as shown in FIGS. 16 and 17, boss 82 of speaker housing 54 is inserted into depression 92 of amplifier housing 51, thus placing the oblique lower panel wall 71 of the speaker housing in contact with the upper oblique panel wall 61 of the amplifier housing. Gripping legs 106, 107, 108 of snap ring 81 are then inserted downwards through central clearance aperture 91 through boss 82, and into an interference fit into central aperture 100 through depression 92 of amplifier housing 51.

As shown in FIG. 13B, the lower end surfaces 126, 127, 128 of barb flanges 113, 114, 115 have angled, ramped surfaces 129, 130. 131, to facilitate insertion into the smaller diameter central aperture 100 through upper oblique panel wall 61 of amplifier housing 51. Contact of the foregoing ramped surfaces with the inner circumferential wall 147 of central aperture 100 causes the lower ends of the gripping legs 106, 107, 108 to elastically deform radially inwards, to thus allow the barbs on the lower ends of the legs to pass axially downward through aperture 100.

When the flat upper edges of the barbs have passed through the aperture 100, elasticity of legs 106, 107, 108 causes the legs to spring radially outwards, thus captivating the snap ring from axial upward movement. With this arrangement, speaker housing 54 is secured against axial movement relative to amplifier housing 51, but free to rotate about an axis directed vertically and perpendicularly through the oblique mating wall panels of the two housings.

As shown in FIGS. 16 and 17, speaker/amplifier device 50 includes a perforated speaker grille 133 which is fastened into an upper rectangular opening 134 in speaker housing 54, as shown in FIG. 6. As is also shown in FIGS. 16 and 17, speaker/amplifier 50 preferably includes a Bluetooth radio frequency transceiver 135. Transceiver 135 has an audio frequency signal output port connected to an input port of audio amplifier 52. This arrangement enables audio signals from various Bluetooth-enabled devices including microphones to be received by transceiver 135, amplified by audio amplifier 52, conducted to loudspeaker 55, and emitted as amplified audio signals from the loudspeaker.

Referring to FIG. 8, it may be seen that speaker/amplifier 50 has an internal power supply 136 that includes battery cells 137 which are held in a battery holder 138. Preferably, as shown in FIG. 8, the battery cells 137 are a rechargeable type and connected through battery charging circuits (not shown) to a USB port 139. With this arrangement USB port 139 can be connected through a cable to a powered USB port such as commonly found on a PC, to thus enable charging batteries 137.

As shown in FIG. 8, battery holder 138 of speaker/amplifier device 50 includes a removable closure lid 140. Device 50 also includes an on/off slide switch 141.

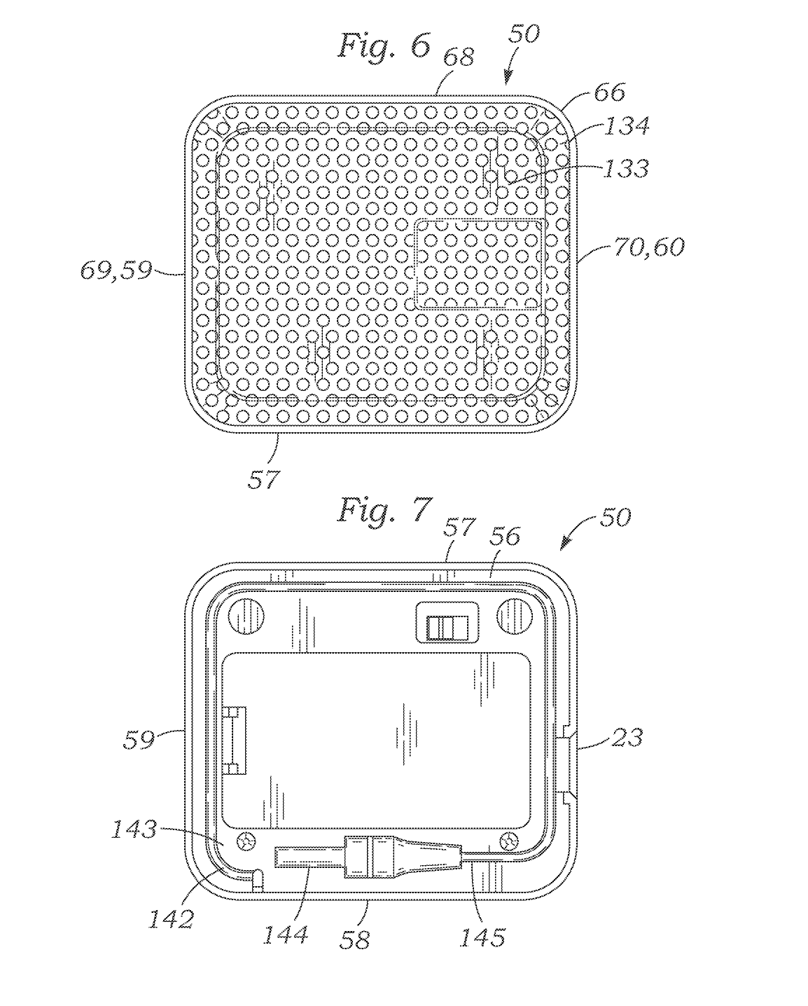

As shown in FIG. 7, speaker/amplifier 50 also preferably includes an auxiliary amplifier input cable 142 which is connected at an inner end through base panel 143 of amplifier housing 54 to amplifier 52, at an outer end thereof to a two-conductor electrical plug 144. Cable 142 and plug 144 fit conformally onto a similarly shaped groove 145 in the bottom surface of base panel 143.

As shown in FIGS. 1 and 3, speaker/amplifier 50 also includes an LED bar display 145 mounted in right-hand wall panel 60 which displays battery charge status. As is also shown in FIGS. 1 and 3, speaker/amplifier 50 also includes a rotary volume control knob 146 which protrudes partially through a slot 147 in right-hand wall panel 60 of amplifier base housing 51.

FIGS. 18-24 illustrate how upper speaker housing 54 is rotatable with respect to lower amplifier housing 51 to thus orient at three different discrete rotation angles relative to base 56 of the amplifier housing a central perpendicular axis to speaker grille 133, which indicates the predominate direction of sounds emitted by loudspeaker 55. Rotational re-configuration of speaker housing 54 relative to amplifier housing 51 is performed by grasping the amplifier housing in one hand, grasping the speaker housing in the other hand, and exerting an upward tensional force on the speaker housing against the elastic force of O-ring 121 to thus withdraw detent buttons 86-89 in the bottom oblique panel wall 71 of the speaker housing from detent depressions 96-99 in the upper oblique panel wall 61 of the amplifier housing. The speaker housing is then rotated 90 degrees counterclockwise to thus realign the detent buttons 86-89 with detent depressions 97, 98, 99 and 96, and tension is then released on the upper speaker housing. The resilience of O-ring 121 then exerts a compressive force to thus re-sea the detent buttons in the detent depressions, thus reorienting speaker housing 54 relative to amplifier housing to a second orientation, as shown in FIGS. 19-21.

In an exactly analogous fashion, speaker housing 54 can be rotated counterclockwise an additional 90 degrees to a third configuration, shown in FIGS. 22-24. From this position, the speaker housing 54 can be re-oriented back to the second or first configurations by grasping the speaker housing and rotating it 90 degrees or 180 degrees clockwise relative to the amplifier housing.

What is claimed is:

1. A portable combination electronic amplifier and loudspeaker device comprising;
a. an amplifier housing,
b. an electronic amplifier contained within said amplifier housing, said amplifier having an input port for receiving audio frequencies, electrical signals and an output port for outputting amplified signals,
c. a speaker housing containing a loudspeaker,
d. a rotatable joint rotatably joining said speaker housing to said amplifier housing,
e. at least a first electrical conductor connecting said output port of said amplifier to an input port of said loudspeaker, and
f. an electrical power source for providing electrical power to said amplifier.

2. The device of claim 1 wherein said joint facilitates orienting an axis of said loudspeaker housing relative to said amplifier housing to different orientation angles selected from a range of values.

3. The device of claim 2 wherein said range of orientation angles comprises at least three discrete angles.

4. The device of claim 3 wherein said amplifier housing is further defined as having a base wall and an upper flat oblique wall panel angled obliquely with respect to said base wall.

5. The device of claim 4 wherein said speaker housing is further defined as having an upper edge wall and a lower flat oblique wall panel angled obliquely with respect to said upper edge wall.

6. The device of claim 5 wherein said lower oblique wall panel of said speaker housing is maintained in parallel overlying relationship to said upper oblique wall panel of said amplifier housing by said rotatable joint.

7. The device of claim 8 wherein said amplifier housing is further defined as having generally the shape of a hollow rectangular cross-section prism having a flat rectangular base and a truncated upper end wall comprised of said upper oblique wall panel of said amplifier housing.

8. The device of claim 7 wherein said speaker housing is further defined as having generally the shape of a hollow rectangular prism having a flat rectangular upper end and a truncated lower end comprised of said lower oblique wall panel of said speaker housing.

9. The device of claim 8 wherein said upper oblique wall panel of said amplifier housing is congruently alignable with said lower oblique wall panel of said speaker housing with said speaker housing oriented at a first, 0-degree orientation angle relative to said amplifier housing.

10. The device of claim 9 wherein said rotatable joint is further defined as having a rotation axis which is perpendicular to said obliqua upper wall panel of said amplifier housing and said oblique lower wall panel of said speaker housing.

11. The device of claim 10 wherein said rotation axis of said rotatable joint is further defined as being centered in said upper oblique wall panel of said amplifier housing and said lower oblique wall panel of said speaker housing.

12. The device of claim 11 wherein said rotatable joint is further defined as facilitating rotational motion in a first sense of said speaker housing a first ninety-degree increment from said first, 0-degree orientation to a second, 90-degree orientation.

13. The device of claim 12 wherein said rotational joint is further defined as facilitating rotational motion of said speaker housing a second ninety-degree increment from said second, 90-degree orientation to a third, 180-degree orientation.

14. The device of claim 13 wherein said rotational joint is further defined as facilitating rotational motion in a second sense of said speaker housing relative to said amplifier housing from said 180-degree orientation to said 90-degree and 0-degree orientations.

15. The device of claim 14 wherein said rotational joint is further defined as including detents for releasably maintaining said speaker housing at said 0-degrees, 90-degrees and 180-degree orientations.

16. The device of claim 15 further including a rotational motion-limiting mechanism for limiting rotational motion of said speaker housing relative to said amplifier housing to 180 degrees.

17. The device of claim 16 wherein said rotational motion limiting mechanism is further defined as comprising in combination a rib which has the shape of 90-degree long circular arc segment which protrudes perpendicularly from a confronting surface of one of said upper and lower oblique wall panels of said amplifier housing and said speaker housing, and a groove that has the shape of a 270-degree long circular arc segment, said groove penetrating a confronting surface of the other of said lower and upper oblique wall panels and rotatably receiving therewithin said rib.

18. The device of claim 17 wherein said rotatable joint is further defined as having a hollow tubular axle.

19. The device of claim 18 wherein at least one of said electrical conductors connecting said output port of said amplifier to said input port of said loudspeaker is disposed axially through a bore through said hollow tubular axle of said rotatable joint.

20. The device of claim 18 wherein said rotatable joint is further defined as including in combination;
a. a snap ring which has a tubular body that is longitudinally segmented to thus from at least a first pair of elastically deformable legs, said tubular body having at an upper head end thereof a transversely disposed head of larger diameter than that of said tubular body,
b. a clearance hole disposed through one of said oblique wall panels of said speaker housing and said amplifier housing, and
c. an interference hole through the other of said oblique wall panel of said amplifier housing and said oblique wall panel of said speaker housing, said interference hole receiving in an interference fit, said tubular body of said ring and being elastically grippable by elastic radial deformation of said legs of said snap ring.
